(19) United States
(12) Patent Application Publication
(10) Pub. No.: US 2005/0192943 A1
(43) Pub. Date: Sep. 1, 2005

(54) Method and apparatus for performing dynamic histogram compression

(76) Inventors: Kashif A. Siddiqui, Austin, TX (US); Awny Al-Omari, Cedar Park, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/790,285

(22) Filed: Mar. 1, 2004

(51) Int. Cl. G06F 7/00

(52) U.S. Cl. 707/3

(57) ABSTRACT

A system that provides compressed histogram data comprises a compiler histogram interface that obtains histogram data about a table in a database, and a dynamic histogram compressor that receives output from the compiler histogram interface, input regarding a database query and table information to produce compressed histogram data for use by an optimizer.

### BACKGROUND OF THE RELATED ART

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Modern computer databases may store immense amounts of data. This data is typically stored in one or more tables that comprise the database. A database may be described as a collection of related records or tuples of information or data. The use of databases in a networked computing environment is an important tool in a modern business environment. A relational database is a popular type of database. In a relational database, a structured set of tables or relations is defined. The tables may be populated with rows and columns of data. The entire collection of tables makes up a relational database.

If a database contains large amounts of data, it may take a relatively long time to perform a query to retrieve data that is of interest to a user. A query is a request by a user to identify a subset of elements of a database. The subset may be referred to as a “view.” The time required for a database to respond to a query may have an adverse impact on the performance of the database as a whole. If the database is subject to a large number of complex queries, the response time for each query may be seriously lengthened.

In complex databases, it may be possible to build views in more than one way depending on the nature of a particular query. Data management languages such as the Structured Query Language (“SQL”) may include a software component known as an “optimizer” for analyzing the various ways of building a view in response to a query. The optimizer may build a search plan that is intended to obtain data responsive to the query using system resources in the most efficient way. This analysis may be referred to as “costing.” The process of costing may include an analysis of statistical data about a given database. This statistical data may include, for example, histogram data that may provide information about the distribution of data elements within a database. Histograms may represent the characteristics of columns of data within a table of the database. For example, a histogram may be used to show the number of unique or different entries in a given column or the like. In a large database, the columns of data may be broken into subsets or intervals and histogram data may be acquired for each of the intervals. A histogram may comprise data that represents a bar chart showing a frequency distribution of a particular data value across successive intervals. For example, if a histogram is represented graphically, it may comprise a plurality of adjacent bars. The width of the bars along the x-axis is typically representative the span of the interval and the heights of the bars typically represents the frequency of occurrence of a particular data value across each of the represented intervals.

Histogram data about a complex database may comprise information about the likelihood that a particular data value will be found if a query is performed in a particular way. Information about the likelihood of data being located in certain portions of a database may provide effective cost optimization by helping to identify a way of performing a query so that the desired data is more likely to be found efficiently.

Histogram data about a database may be created periodically and stored as part of the database's configuration information. This configuration may be stored as metadata (data about data) associated with the database so that it may be used repeatedly by the optimizer to optimize queries. In large or complex databases, the time required to access and employ the stored histogram data to create a search plan may contribute to decreased database performance.

### BRIEF DESCRIPTION OF THE DRAWINGS

Advantages of one or more disclosed embodiments may become apparent upon reading the following detailed description and upon reference to the drawings in which:

FIG. 1 is a block diagram illustrating a computer network in accordance with embodiments of the present invention;

FIG. 2 is a diagram illustrating histogram data in accordance with embodiments of the present invention;

FIG. 3 is a block diagram showing a database system compiler (query plan generator) in accordance with embodiments of the present invention;

FIG. 4 is a diagram illustrating a dynamic histogram compression mechanism in accordance with embodiments of the present invention; and

FIG. 5 is a block diagram illustrating the flow of a process in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

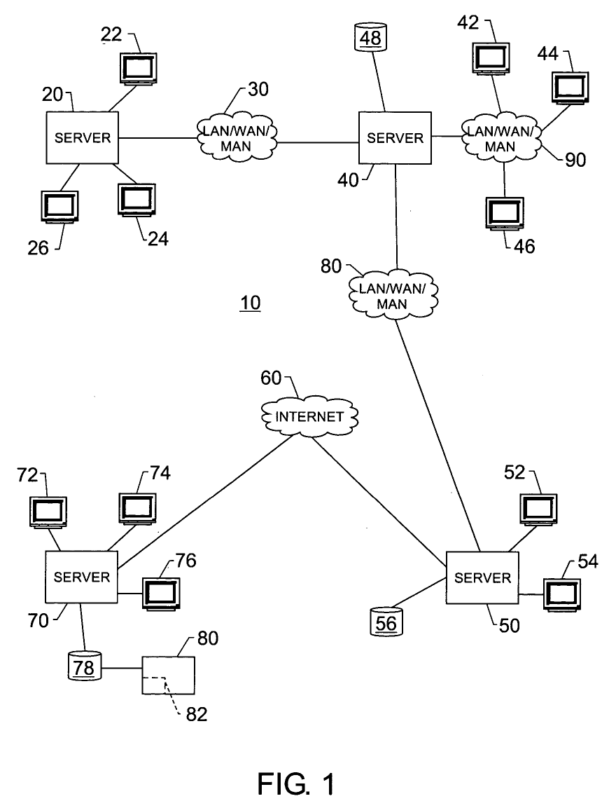

Turning now to the drawings and referring initially to FIG. 1, a block diagram of a computer network is illustrated and designated using a reference numeral 10. A server 20 may be connected to a plurality of client computers 22, 24 and 26. The server 20 may be connected to as many as “n” different client computers.

The server 20 may be connected via a network infrastructure 30, which may include any combination of hubs, switches, routers, and the like. While the network infrastructure 30 is illustrated as being either a local area network (“LAN”), storage area network (“SAN”) a wide area network (“WAN”) or a metropolitan area network (“MAN”), those skilled in the art will appreciate that the network infrastructure 30 may assume other forms or may even provide network connectivity through the Internet. As described below, the network 10 may include other servers, which may be dispersed geographically with respect to each other to support client computers in other locations.

The network infrastructure 30 may connect the server 20 to server 40, which may be representative of any other server in the network environment of server 20. The server 40 may be connected to a plurality of client computers 42, 44, and 46. As illustrated in FIG. 1, a network infrastructure 90, which may include a LAN, a WAN, a MAN or other network configuration, may be used to connect the client computers 42, 44 and 46 to the server 40. A storage device 48 such as a hard drive, storage area network, RAID array or the like may be attached to the server 40. The storage device 48 may be used to store a database or portion of a database for use by other network resources. Portions or partitions of a single database may be stored on various different storage devices within the network 10.

The server 40 may be connected to server 50, which may be connected to client computers 52 and 54. A network infrastructure 80, which may include a LAN, a WAN, a MAN or other network configuration, which may be used to connect the client computers 52, 54 to the server 50. A storage device 56 such as a hard drive, storage area network (“SAN”), RAID array or the like may be attached to the server 50. The storage device 56 may be used to store a database or portion of a database for use by other network resources.

The server 50 may additionally be connected to the Internet 60, which may be connected to a server 70. The server 70 may be connected to a plurality of client computers 72, 74 and 76. The server 70 may be connected to as many client computers as its computing capacity may allow. A storage device 78 such as a hard drive, storage area network (“SAN”), RAID array or the like may be attached to the server 40. The storage device 78 may be used to store a database 80, which may comprise a portion of a database, for use by other network resources. The database 80 may comprise configuration information, which may take the form of metadata 82 (shown in dashed lines). The metadata 82 may comprise statistical information about the database 80, such as histogram data. Those of ordinary skill in the art will appreciate that the histogram data may be cached so that it is readily accessible to assist in the optimization of data base queries.

Those of ordinary skill in the art will appreciate that the servers 20, 40, 50, and 70 may not be centrally located. Accordingly, the storage devices 48, 56 and 78 may also be at different locations. A network architecture, such as the network architecture 10, may typically result in a wide geographic distribution of computing and database resources.

A database may be accessed through an application program, which may be referred to as a database management system or “DBMS.” The DBMS typically performs database management functions. The DBMS may additionally allow users to add new data to the database or access data that is already stored in the database. A query may be performed across an entire relational database and may request data from one or more tables within the database. The organization of the data requested by a query may be called a “view.” Views may not exist independently within the database, but may only exist as the output from a query.

In a networked computing environment, the information stored in a database may not all be in a centralized location. Portions of data in a single relational database may be stored on different servers on different network segments, or even in different cities or countries. To make processing the information faster, a relational database may be partitioned among a number of servers to allow parallel processing of queries. Queries may be optimized by an optimizer to improve system performance. The use of statistical information about the database, such as distributions of data and the like, may be used to optimize queries. This data may be in the form of histograms.

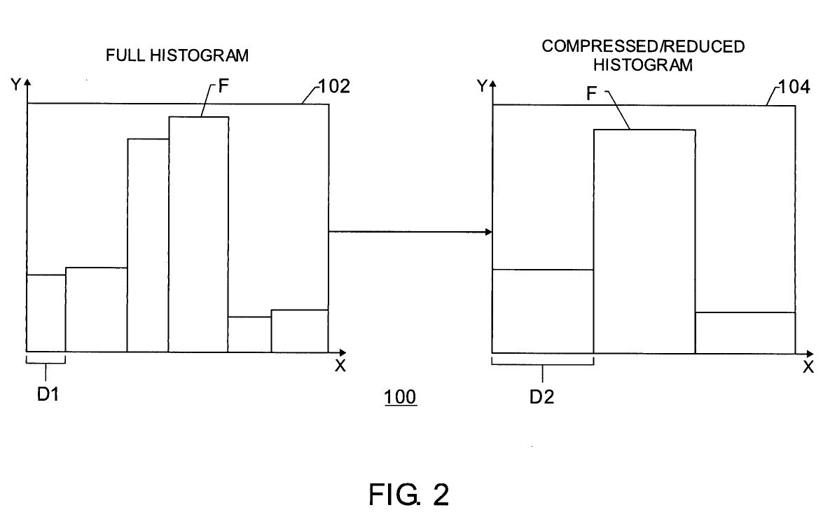

FIG. 2 is a diagram illustrating histogram data in accordance with embodiments of the present invention. The diagram is generally referred to by the reference numeral 100. As set forth above, histogram data may be used to optimize queries to the database to improve system performance. The time used to optimize a query using histogram data may be reduced by using dynamically compressed histogram data, which may be based on full histogram data generated by the DBMS of the database.

A full histogram diagram 102, which may be a representation of statistical data prepared by the DBMS of a database, may comprise information about the composition and likelihood of occurrence of data items within the database. The full histogram diagram 102 shows the frequency of occurrence of a data item over a plurality of intervals. Each of the intervals extends a predetermined distance D along the x-axis. The frequency of occurrence of a particular data item for each of the intervals is illustrated by the height F of the frequency bar for that interval. The height of the frequency bar F shows the magnitude of the frequency on the y-axis.

The use of full histogram data to perform query optimization may take a relatively long period of time. Embodiments of the present invention employ dynamically reduced or compressed histogram data as illustrated in the compressed or reduced histogram diagram 104 to optimize queries. As explained below, the compressed or reduced histogram data illustrated in the diagram 104 is created by combining intervals where appropriate with respect to the full histogram data shown in the full histogram diagram 102. The use of compressed histogram data may improve query optimization by reducing optimization time.

If histogram data can be reduced to one interval, a significant amount of time may be saved in the compilation of an optimized query plan after a query is received. Compile time may be improved to a lesser extent by reducing the number of intervals, even though reduction to a single interval is not feasible because of the effect on the quality of the resulting search plan.

The performance improvements occur because histogram data is used for costing (i.e. determining the most cost effective search plan for a give query in terms of system resources). If the number of intervals is reduced, this means that less data must be processed for a given optimization operation. Histogram data may also be used for computing intermediate histograms, which may be used for costing. Reducing the number of intervals may result in faster computation of these intermediate histograms and improved memory usage.

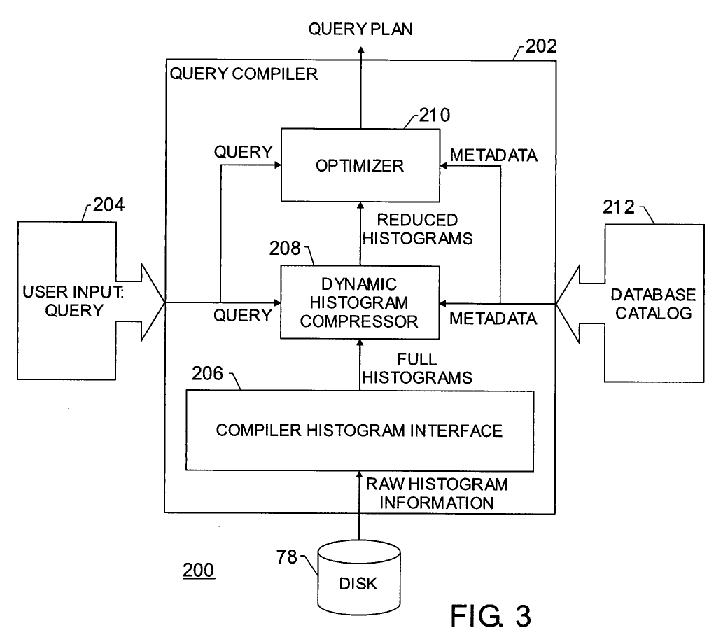

Design criteria for a dynamic histogram compression methodology and system in accordance with embodiments of the present invention may include the dynamic reduction of the number of histogram intervals to achieve performance improvements and minimizing the degradation to search plan quality. The creation of compressed histogram data is explained with reference to FIG. 3.

FIG. 3 is a block diagram showing a database system compiler (query plan generator) in accordance with embodiments of the present invention. The system is generally referred to by the reference numeral 200. This system includes a query compiler 202. The query compiler 202 comprises a compiler histogram interface 206, a dynamic histogram compressor 208, and an optimizer 210. In response to a user query 204, raw histogram data may be read from a disk 78 (FIG. 2). The data stored on the disk 78 may comprise statistical metadata of the type computed periodically by the DBMS (not shown) of the database system. The compiler histogram interface 206 transforms the full or complete histogram data into a format that may be used for query optimization, as will be appreciated by those of ordinary skill in the art.

The following rules or guidelines may be employed to create dynamically compressed histograms:
1. Reduce the number of histogram intervals for data columns containing numeric data types.
2. Reduce the number of histogram intervals for non-numeric data columns only if there is no join or range predicate on them. The reason for this guideline comes from the fact that, unlike numeric values, there is no real sense of distance between two non-numeric values (for example, there is no definitive way to compute a distance between the strings “near” and “far”). Consequently, the distance between non-numeric data objects cannot be concretely determined.
3. The histogram interval reduction may be selectably switched on or off based on predetermined criteria.

In using these guidelines to create dynamically compressed histograms by reducing the number of histogram intervals, at least four issues may be addressed. The first consideration is the identification of when and where to reduce the number of histogram intervals. In one embodiment of the present invention, the number of histogram intervals may be reduced immediately after full histograms are generated by the DBMS. This full generation of histograms may take place when the optimizer 210 obtains histograms from histogram tables on disk via the compiler histogram interface 206.

A second consideration is how to reduce the number of histogram intervals for a column, which may be performed by the dynamic histogram compressor 208. The reduction may be done using a linear algorithm. Such an algorithm may start from the first interval comparing it to the adjacent one, and merge them if the criterion for merging (described below) is satisfied. Subsequently, the algorithm may proceed to the next interval, applying the same logic, until the last interval has been considered. Different versions of a data column's histogram with reduced number of intervals may be produced by using different interval-merging criteria. The version of a data column's reduced histogram used by the optimizer may be programmed to depend on multiple factors.

One factor that may affect the determination of merge criterion is the data type of the data contained in that data column. For example, the criterion may be different for non-numeric data (CHAR or VARCHAR data types, or the like). Another factor that may affect the determination of merge a merge criterion may be whether the data column has an identified join or range predicate on it.

A third consideration may include interaction with histogram caching. The compiler histogram interface 206 may comprise a histogram cache that provides a framework to cache histograms with reduced numbers of intervals. The caching of compressed histogram data in memory, such as random access memory instead of disk storage, may enhance system performance by supplying cached versions of the reduced histogram and avoiding the reduction process for the histograms that are already in the cache.

A fourth consideration may include how histograms are fetched and whether system performance may be improved using prefetching. Without histogram caching, histograms may be fetched for every statement and then discarded at the end of the statement. Histograms may be fetched for all the data columns of a given table, and then the histograms for data columns that were not needed may be discarded. If histogram caching is employed, fetching histograms for all the data columns of a table and putting them in the cache can achieve additional performance and code simplicity. Histogram caching may also simplify caching of histograms with reduced number of intervals.

The output of the compiler histogram interface 206 is delivered to the dynamic histogram compressor 208. As set forth in greater detail below, the dynamic histogram compressor 208 produces compressed or reduced histogram data where appropriate. The compressed or reduced histogram data is delivered to the optimizer 210 which optimizes a user query 204 to formulate a search plan in response to the query. In formulating the reduced or compressed histogram data for the optimizer, the dynamic histogram compressor 208 may additionally receive database catalog information 212, which may be in the form of metadata for the database. The database catalog or table information 212, which may include data column type information and the like, may be used to determine whether the intervals of full histogram data may be compressed, while still maintaining an acceptable level of resolution to prepare an effective search plan. The compile time for each query that uses compressed histogram data may be reduced relative to the compile time for optimization of queries based on full histogram data because the compressed histogram data has fewer elements that require calculation. This is true because the compressed data represents the full histogram data with a relatively simplified approximation of the full histogram data.

Similarity criteria may be used by the dynamic histogram compressor 208 in deciding whether to reduce the number of intervals relative to the full histogram data for a given query. This decision process makes the use of compressed histogram data a dynamic function for each query. The use of fewer intervals in the form of compressed histogram data by the optimizer may reduce the amount of time the optimizer 210 takes to optimize a query.

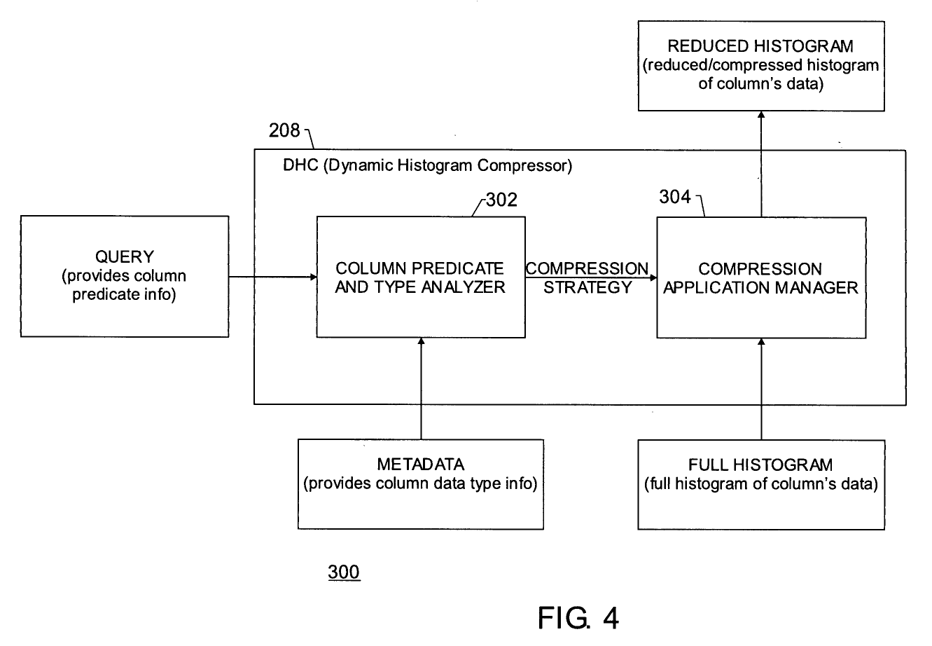

FIG. 4 is a diagram illustrating a dynamic histogram compression mechanism in accordance with embodiments of the present invention. The dynamic histogram compression mechanism is generally referred to by the reference numeral 300. The dynamic histogram compression mechanism 300 includes the dynamic histogram compressor 208 (FIG. 3). The dynamic histogram compressor 208 comprises a column predicate and type analyzer 302 and a compression application manager 304. The column predicate and type analyzer 302 receives information about the query and table information that may be obtained from a source such as the database catalog 212 (FIG. 3). The query information may comprise information that indicates particular columns in the database. The table information may comprise information relating to the type of data in each data column. The column predicate and type analyzer 302 produces a compression strategy or algorithm, which is delivered to the compression application manager 304. The compression application manager 304 receives full or complete histogram data and produces the customized reduced histogram or compressed histogram data based on the compression strategy or algorithm.

In a typical database environment, such as a SQL database environment, full histograms are initially fetched when the optimizer 210 (FIG. 3) requests statistics for tables on the disk. This may be done when the optimizer 210 (FIG. 3) calls a method to fetch statistical data or a histogram cache method, depending on whether histogram caching is turned off or on. Data from histogram tables may be fetched from disk and the statistics may be filled into an internal histogram data structure. Therefore, to reduce the number of intervals in the initially generated histograms, a call to the histogram compression routine may be made after calls to a fetch histogram utility have retrieved the histogram statistics from disk. The compression routine may be executed under the control of the dynamic histogram compressor 208.

The dynamic histogram compressor 208 reduces the number of histogram intervals by applying a set of possible compression strategies or algorithms to iteratively merge two intervals into one interval. For example, adjacent intervals may be merged into one interval if they are approximately equal based on certain predetermined merge criteria. These criteria may be determined dynamically based on the data type and predicates on a particular data column.

Each histogram interval may be thought of as embodying four pieces of information:
1. Row count (“RC”), which may be equal to the number of rows in a given interval).
2. Unique entry count (“UEC”), which may be equal to the number of unique entries in a given interval ((for example, the number of different first names in a “first name” data column).
3. Beginning value (“BV”).
4. Ending Value (“EV”).
   The difference EV minus BV represents the length of the interval or the distance (“D”) between the BV and EV.

The following sets forth two exemplary interval merging criteria that may be applied to merge the intervals of a given data column's histogram in order to reduce the number of intervals. One of the following criteria will be used in order to merge two intervals of a histogram. The following discussion includes an exemplary methodology for determining which of the two merge criterion to use for a particular case:

Intervals a and b may be defined to be adjacent if, by definition, ((EVₐ=BV_{b}) or (EV_{b}=BVₐ)). A first merge criterion (“Merge Criterion 1”) may be expressed, as follows: Two adjacent intervals ‘a’ & ‘b’ may be merged if (RCₐ//Daₐ≈RC_{b}/D_{b} and UECₐ/Dₐ≈UEC_{b}/D_{b}). Note that the interval resulting from the merge (interval ‘c’) satisfies RCₐ/Dₐ≈RC_{b}/D_{b}≈RC_{c}/D_{c} and also UECₐ/Dₐ≈UEC_{b}/D_{b}≈UEC_{c}/D_{c}.

A second merge criterion (“Merge Criterion 2”) may be expressed, as follows: Two adjacent intervals ‘a’ & ‘b’ can be merged if RCₐ/UECₐ≈RC_{b}/UEC_{b}. Note that the interval resulting from the merge (interval ‘d’) satisfies RCₐ/UECₐ≈RC_{b}/UEC_{b}≈RC_{d}/UEC_{d}.

It should be noted that the symbol ‘≈’ implies approximate equality. For purposes of determining whether to merge adjacent intervals, intervals are approximately equal if they have values Vₙ that fall within an Acceptable Distance AD of each other. Any of the following expressions may be employed as the value Vₙ of a given row:
RCₙ/Dₙ
UECₙ/Dₙ
RCₙ/UECₙ
The same expression should be used to evaluate each data column to determine its value. As an example of using the first expression to determine the AD between data columns, the following equation applies:
V₁≈V₂(RC₁/D₁≈RC₂/D₂) iff |V₁−V₂|<AD.

The acceptable difference AD is composed of the following components:
AD=\sqrt{RPD²+T₁²+T₂²}
where the Relative Permissible Difference (RPD) is a component that accounts for allowed percentage differences between the two values:
RPD=PR*(V₁+V₂)/2
where PR is a predefined permissible ratio value (for example, 10%). In other words:
RPD=PR* Average of (V₁, V₂).
T₁ and T₂ represent tolerance values corresponding to V₁ and V₂.

As an example, assume two adjacent intervals int₁ and int₂ with UEC₁=UEC₂=1, D₁=D₂=1, RC₁=7, and RC₂=8. Note that even though int₁ and int₂ are close, a difference of 1 between RC₁ and RC₂ constitutes a percentage difference of more than 13% (which exceeds a PR of 10%). The proposed tolerance component will take care of such cases. The tolerance (T) will be calculated as follows:
For Vₙ=RCₙ/Dₙ, Tₙ=α×\sqrt{RCn}/Dn
For Vₙ=UECₙ/Dₙ, Tₙ=α×\sqrt{UECn}/Dn
For Vₙ=RCₙ/UECₙ, Tₙ=α×√ RCn/UECr
whereα (alpha) is a constant between 0 and 1, which may be adjusted if desired (a possible initial value may be in the range of 0.5, for example).

The tolerance formulas take into account the standard deviation of random distribution of records in the two intervals. The density values may be assigned a tolerance amount similar to the uncertainty of theses values had the records been distributed randomly between the two intervals.

For the example above,
For V=RC/D,
V₁=7/1, T1=0.5×\sqrt{7}/1=1.32
V₂=8/1, T2=0.5×\sqrt{8}/1=1.41
RPD=0.1×(7+8)/2=0.75
AD=sqrt(1.32\hat{ }2+1.41\hat{ }2+0.75\hat{ }2)=2.07
|V₁−V₂|=1<2.07→V₁≈V_{2.}

As set forth above, the criterion used for merging a data column's histogram depends on the data type of the column and whether the data type is non-numeric. If the data type of a column is non-numeric (e.g. CHAR or VARCHAR), then for a given histogram interval, distance cannot be quantified. Therefore, only Merge Criterion 2 may be used depending on the predicates on the data column (which also means that Merge Criterion 1 should not be applied to non-numeric columns).

If a data column has a range predicate defined on it, this means that the query being evaluated includes an inequality with a constant (for example, age <25). When determining whether to merge a column with a range predicate, that column should be reduced using Merge Criterion 1. This is because Merge Criterion 2 does not maintain range information, as it does not factor in distance.

If a data column has a join predicate defined on it, this means that the query being evaluated requires evaluation of data from multiple tables. When determining whether to merge a data column with a join predicate, that data column should be reduced using Merge Criterion 1 as well. This is because range information is used in estimating the histogram of the intermediate tables resulting from join operations.

Range information that is maintained by factoring in the distance in Merge Criterion 1, is not significant for other kinds of predicates (e.g. equality). Density, which may be defined as row count per unique entry, is much more significant in these cases. Merge Criterion 2 should, therefore, be used in cases where a predicate other than range or join exists on a data column. Those of ordinary skill in the art will appreciate that a column's predicate information may be determined in an area of the database known as the binder, which performs preliminary error checking for a query before processing by the optimizer 210 (FIG. 3).

The following discussion relates to the use of histogram caching. The compiler histogram interface 206 (FIG. 3) may comprise a histogram cache that provides a framework to cache histogram data for faster access. This framework may be adapted to cache histograms with reduced number of intervals. Caching histograms with reduced numbers of intervals may help to reduce the overall cost of providing compressed histogram data because compressed histogram data stored in the cache does not need to be computed again for subsequent operations.

A histogram cache in accordance with embodiments of the present invention may comprise two internal caches. One of the internal caches may be employed to store full or complete histogram data, and the other internal cache may be used to store compressed or reduced histogram data. It may be desirable to give control of whether histogram caching is used to a logical entity within the histogram caching layer of the database to avoid multiple calls to a utility that fetches histogram data. A flag identifying whether histogram caching is turned on or off may be implemented in the histogram caching layer. This may help avoid code redundancy and provide a unified interface to when histograms are requested, without regard to histogram caching.

If histogram caching is used, histograms may be maintained across statements in the cache. Therefore, fetching histograms for all the data columns of a table and putting them in the cache can achieve additional performance. Prefetching may require that a histogram obtaining utility does not discard statistics for data columns not relevant to the current statement. Instead, the histogram fetching utility may return statistics for all the data columns of a table whose statistics are requested.

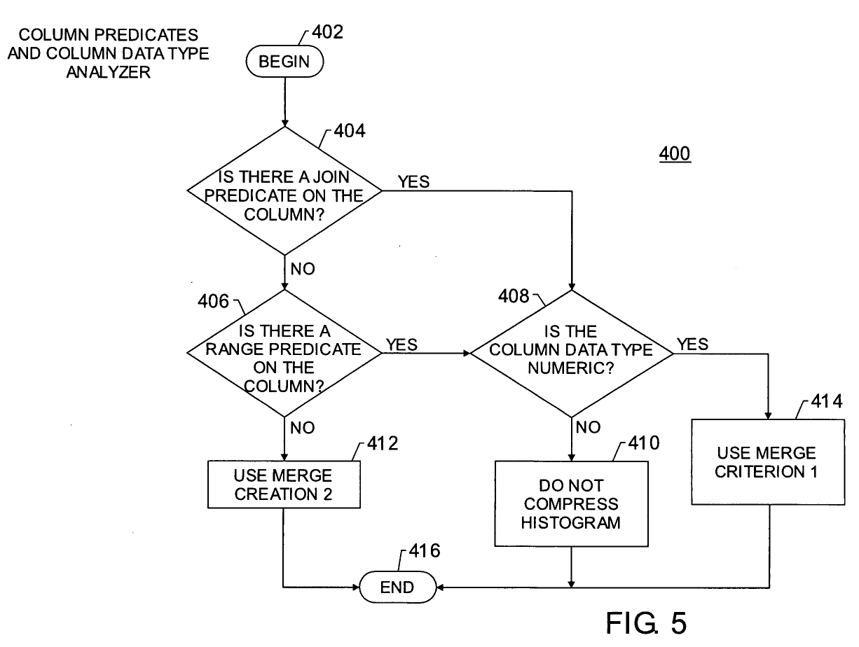

FIG. 5 is a block diagram illustrating the flow of a process in accordance with embodiments of the present invention. The process is generally referred to by the reference numeral 400. At block 402, the process begins. The process shown in FIG. 5 is illustrative of one embodiment of the operation performed by the data column predicate and type analyzer 302 to produce a compression strategy or algorithm. At block 404, a decision is made as to whether a join predicate exists on the data column. If a join predicate does exist on a particular data column, a decision is made at block 408 as to whether the data column type for the particular data is numeric. If the data type is non-numeric, then no compression is performed, as shown at block 410. If the data column type indicates that the data is numeric, then Merge Criterion 1 is provided as compression strategy or algorithm output from the column predicate and type analyzer 302 (FIG. 4), as shown at block 414.

If, at block 404, there is no join predicate on the data column, a determination is made as to whether there is a range predicate on the data column at block 406. If there is a range predicate on the column, a determination is made as to whether the column type is numeric at block 408, and processing continues as described above. If, at block 406, there is no range predicate on the data column, then Merge Criterion 2 is output by the column predicate and type analyzer 302 as the compression strategy or algorithm, as shown at block 412.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A system that provides compressed histogram data, comprising:
a compiler histogram interface that obtains histogram data about a table in a database; and
a dynamic histogram compressor that receives output from the compiler histogram interface, input regarding a database query and table information to produce compressed histogram data for use by an optimizer.

2. The system set forth in claim 1, wherein the optimizer prepares a search plan based on the compressed histogram data.

3. The system set forth in claim 1, wherein the compressed histogram data is determined by combining intervals of the histogram data.

4. The system set forth in claim 3, wherein intervals are combined based at least in part on a column type.

5. The system set forth in claim 3, wherein intervals are combined based at least in part on whether a range predicate is defined on a column of the table.

6. The system set forth in claim 3, wherein intervals are combined based at least in part on whether a join predicate is defined on a column of the table.

7. The system set forth in claim 1, wherein the dynamic histogram compressor comprises:
a column predicate and type analyzer that produces a compression strategy; and
a compression application manager that receives the compression strategy and produces the compressed histogram data.

8. The system set forth in claim 1, wherein the table data comprises column type data about the table.

9. The system set forth in claim 1, wherein the table data comprises data regarding whether a predicate has been defined on a column of the table.

10. The system set forth in claim 1, wherein the table data comprises metadata.

11. A database system, comprising:
a plurality of networked computers, each storing at least a portion of a database:
a compiler histogram interface that obtains histogram data about a table in the database; and
a dynamic histogram compressor that receives output from the compiler histogram interface, input regarding a database query and table information to produce compressed histogram data for use by an optimizer.

12. The database system set forth in claim 11, wherein the optimizer prepares a search plan based on the compressed histogram data.

13. The database system set forth in claim 11, wherein the compressed histogram data is determined by combining intervals of the histogram data.

14. The database system set forth in claim 13, wherein intervals are combined based at least in part on a column type.

15. The database system set forth in claim 13, wherein intervals are combined based at least in part on whether a range predicate is defined on a column of the table.

16. The database system set forth in claim 13, wherein intervals are combined based at least in part on whether a join predicate is defined on a column of the table.

17. The database system set forth in claim 11, wherein the dynamic histogram compressor comprises:
a column predicate and type analyzer that produces a compression strategy; and
a compression application manager that receives the compression strategy and produces the compressed histogram data.

18. The database system set forth in claim 11, wherein the table data comprises column type data about the table.

19. The database system set forth in claim 11, wherein the table data comprises data regarding whether a predicate has been defined on a column of the table.

20. The database system set forth in claim 11, wherein the table data comprises metadata.

21. The database system set forth in claim 11, wherein the database is a distributed database.

22. A method of creating a search plan for a database, the method comprising the acts of:
obtaining histogram data about a table in a database, input regarding a database query and table information;
producing compressed histogram data based on the histogram data, the input regarding the database query and the table information; and
using the compressed histogram data to produce a search plan to search the database in response to the query.

23. The method set forth in claim 22, comprising combining intervals of the histogram data to form the compressed histogram data.

24. The method set forth in claim 22, comprising:
producing a compression strategy based on the table information; and
using the compression strategy to produce the compressed histogram data.

25. A system that provides compressed histogram data, comprising:
means for obtaining histogram data about a table in a database; and
means for receiving output from the compiler histogram interface, input regarding a database query and table information to produce compressed histogram data for use by an optimizer.

26. A computer program, comprising:
a machine-readable media;
a compiler histogram interface stored on the machine readable that obtains histogram data about a table in a database; and
a dynamic histogram compressor stored on the machine readable media that receives output from the compiler histogram interface, input regarding a database query and table information to produce compressed histogram data for use by an optimizer.
